(19) United States
(12) Patent Application Publication
(10) Pub. No.: US 2009/0299656 A1
(43) Pub. Date: Dec. 3, 2009

(54) TYRE MANAGING APPARATUS

(75) Inventor: Noritaka Koguchi, Hiratsuka-shi (JP)

Correspondence Address: GREER, BURNS & CRAIN, 300 S WACKER DR, 25TH FLOOR, CHICAGO, IL, 60606, US

(73) Assignee: THE YOKOHAMA RUBBER CO., LTD., Tokyo (JP)

(21) Appl. No.: 12/467,864

(22) Filed: May 18, 2009

(30) Foreign Application Priority Data
Jun. 3, 2008 (JP) 2008-145835

(51) Int. Cl. G01L 1/00; G01K 13/00; B60C 23/02

(52) U.S. Cl. 702/42; 702/41; 702/130; 73/146.3

(57) ABSTRACT

In this tyre managing apparatus, with regard to respective tyres, the back-and-forth force and the lateral force which are added to each of tyres are calculated based on the distances which are distance between each tyre and the center of gravity in the back-and-forth direction, the inertia moment of the vehicle, the vehicle weight of the vehicle, and the loads added to each of the tyres, which are as specification data of the vehicle, and based on the longitudinal acceleration, the lateral acceleration, and the yew angle acceleration, which are as state quantities of the vehicle. Also, the calculated results are memorized in the transponders of corresponding tyres.

### BACKGROUND OF THE INVENTION

(i) Field of the Invention

The present invention relates to, for example, a tyre managing apparatus for managing tyre quality of portions except the tread portion of vehicle tyre which is used after retreading.

(ii) Description of the Related Art

Generally, as a such kind of tyre managing apparatus, it is known that a apparatus which detects a temperature of tyre, air pressure of tyre and climate condition, and which calculates the wear loss of the tread portion of the tyre based on the detected results and the traveling distance of the vehicle, with considering that the ratio of the wear loss of the tread varies according to the temperature of the tyre, dry condition of the road, and like that. The tyre managing apparatus estimates the change timing of tyres or the rotation timing.

By using the tyre managing apparatus, it is possible to manage the wear loss of the tread portion of the tyre by calculating the amount of the wear loss of the tread portion. However, it is impossible to manage tyre quality of portions except the tread portion of the tyre.

### SUMMARY OF THE INVENTION

An object of the present invention is to provide a tyre managing apparatus capable of managing tyre quality of portions except the tread portion of tyre.

The present invention is a tyre managing apparatus for managing a force which is added to each tyre or a coefficient thereof, and for managing the force or the coefficient at respective tyres of vehicle installed with tyres to which a plurality of transponders are respectively attached, the tyre managing apparatus comprising a memory for memorize a specification data of the said vehicle, a detecting device for detecting a state quantity of the vehicle, a computing device for computing the said force or the said coefficient at respective tyres using at least the specification data of vehicle of the memory and the detected state quantity, and a transmitter for transmitting the force or the coefficient computed by the computing device to the transponder of corresponding tyre, the transmitter for making the transponder memorize the force or the coefficient.

Also, the present invention is a tyre managing apparatus for managing a force which is added to each tyre or a coefficient thereof, for managing the force or the coefficient at respective tyres of vehicle installed with tyres to which a plurality of transponder are respectively attached, the tyre managing apparatus comprising a memory for memorize a specification data of the said vehicle, a detecting device for detecting a state quantity of the vehicle, a computing device for computing the said force or the said coefficient at respective tyres using at least the specification data of vehicle of the memory and the detected state quantity, a making frequency distribution data device for making the data of frequency distribution of the force or the coefficient which are computed by the computing device at respective tyres, and a transmitter for transmitting the data of frequency distribution made by the making frequency distribution data device to the transponder of corresponding tyre, the transmitter for making the transponder memorize the data of frequency distribution.

By this, at respective tyres, the force added to the tyre or the coefficient thereof is computed by using the specification data of vehicle and state quantity of the vehicle. Also, the computed result is memorized in the transponders of corresponding tyres. Thus, as specification data of vehicle, by using the weight of the vehicle, the weight added to each tyre, and the inertia moment generate to each tyre, as state quantities of vehicle, by using the longitudinal acceleration, the lateral acceleration, and the yaw angle acceleration, it is possible to compute forces added to each of tyres. Also, the computed results are memorized in each of the transponders of corresponding tyres.

Therefore, by reading the computed results in the transponders afterward, it is possible to confirm easily and certainly the history of the forces which are added to the tread portion and the portions except the tread portion of the tyre. Thus, it is extremely advantageous for managing tyre quality of portions except the tread portion of tyre.

The above-mentioned objects, other objects, features, and benefits of the present invention will become clear by the following description and accompanying drawings.

### BRIEF DESCRIPTION OF THE DRAWINGS

FIG. 1 is an outlined plan view of a tyre managing apparatus and a vehicle showing the first embodiment of the present invention;

FIG. 2 is an example of dynamics models of the vehicle;

FIG. 3 is an outlined view of a circuit of a transponder;

FIG. 4 is an outlined plan view of a tyre managing apparatus and a vehicle showing the second embodiment of the present invention;

FIG. 5 is an example of frequency distribution data;

FIG. 6 is another example of dynamics models of the vehicle.

### DESCRIPTION OF THE PREFERRED EMBODIMENTS

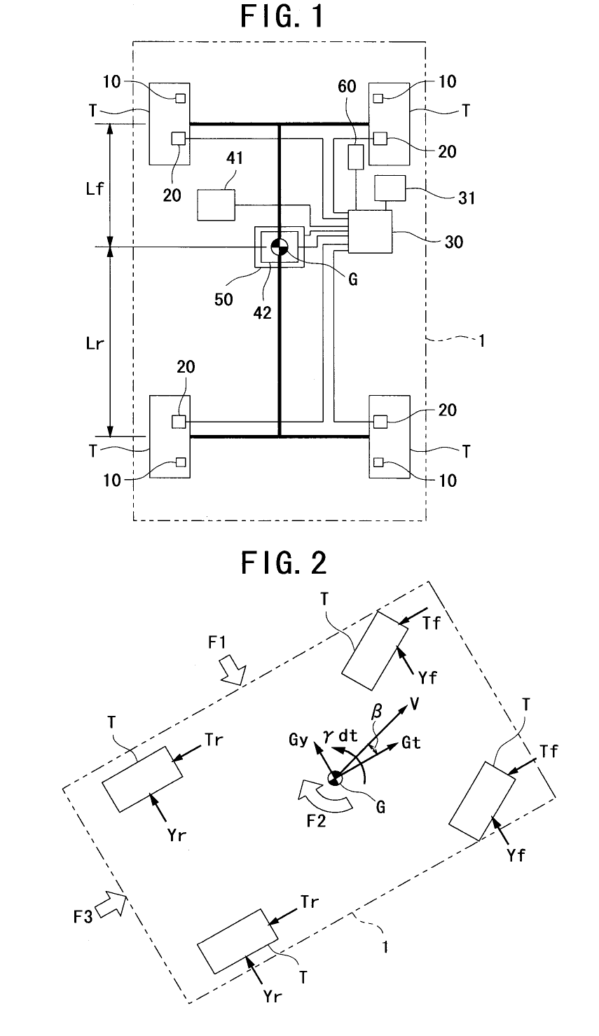

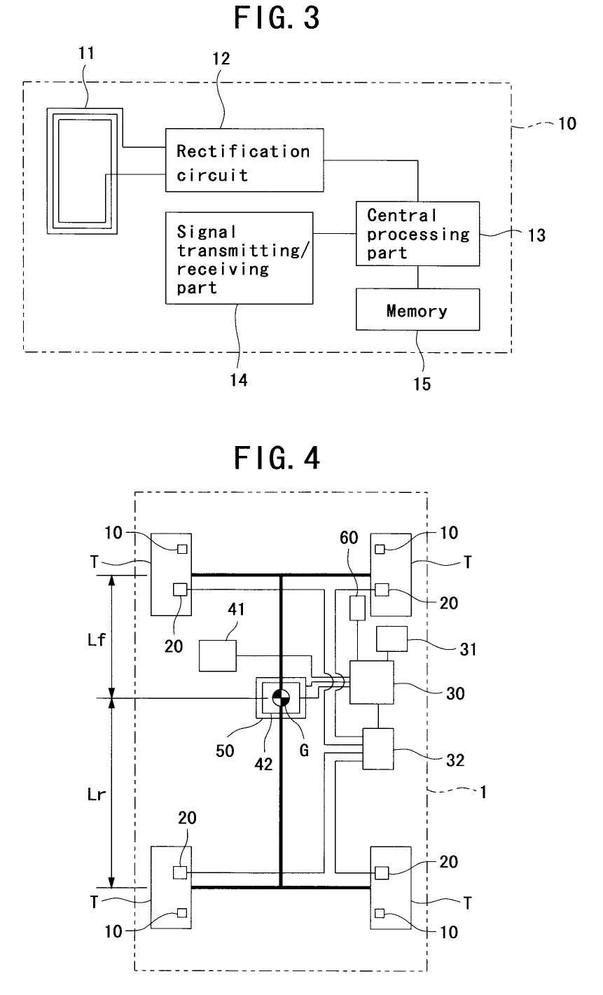

FIGS. 1 to 3 show the first embodiment of the present invention. FIG. 1 is an outlined plan view of a tyre managing apparatus and a vehicle, FIG. 2 is an example of dynamics models of the vehicle, FIG. 3 is an outlined view of a circuit of a transponder.

This tyre management apparatus has a plurality of antennas 20 provided on a vehicle 1, a control device 30, a memory 31, a first acceleration sensor 41 for detecting backward and forward acceleration of the vehicle 1, a second acceleration sensor 42 for detecting lateral acceleration of the vehicle 1, a yew acceleration sensor 50, and a speed sensor 60. Also, the vehicle 1 is a well known automobile having two tyres T each at rear side and front side respectively. Each tyre T is respectively provided with well known transponder 10 for transmitting information and receiving information of the outside by using the electromagnetic wave. It is possible to bury the transponder 10 into the bead portion, the sidewall portion, the inner surface of the tread portion, or the like.

Each antennas 20 is provided on the vehicle 1 so as to correspond to transponders of each of the tyres. Each antenna 20 transmits data, which is transmitted from the control device 30, to each transponder 10.

As shown in FIG. 3, The transponder 10 has, for example, an antenna 11, a rectification circuit 12, a central processing part 13, a signal transmitting/receiving part 14, a memory 15. when a data is transmitted from the antenna 20 of vehicle 1 to the transponder 10 by using the electromagnetic wave, an AC current is generated in the antenna 11 by the said electromagnetic wave, the said current is rectified into a DC current by the rectification circuit 12, the said DC current is used for driving source for the central processing part 13, the signal transmitting/receiving part 14, and the memory 15. Also, the said AC current is recognized through the signal transmitting/receiving part 14 by the central processing part 13 as a data, and the data is memorized by the memory 15. Moreover, the data memorized in the memory 15 are readable by the well known reader/writer or the like.

As shown in FIG. 1, each of the front side tyres T is disposed at a position which is away from the center of gravity G of the vehicle 1 by the distance Lf in the back-and-forth direction of the vehicle 1. Also, each of the rear side tyres T is disposed at a position which is away from the center of gravity G of the vehicle 1 by the distance Lr in the back-and-forth direction of the vehicle 1.

The first acceleration sensor 41 is provided on the vehicle 1, the longitudinal acceleration Gt is detected by the first acceleration sensor 41. The longitudinal acceleration Gt is the acceleration in the back-and-forth direction of the vehicle 1. The second acceleration sensor 42 is provided at the center of gravity G of the vehicle 1, the lateral acceleration Gy is detected by the second acceleration sensor 42 in the center of gravity G. The lateral acceleration Gy is the acceleration in the lateral direction of the vehicle 1. Also, the yew acceleration sensor 50 is provided at the center of gravity G of the vehicle 1, the yew acceleration sensor 50 is capable of detecting the yew angle acceleration γ dt of the vehicle 1 and made of well known gyro sensor or the like. Moreover, the speed sensor 60 is provided on the vehicle 1, the speed sensor 60 is capable of detecting the speed V of the vehicle 1.

The control device 30 is connected to the memory 31. Also, the control device 30 is connected to each antenna 20, the first acceleration sensor 41, the second acceleration sensor 42, yew acceleration sensor 50, and the speed sensor 60 (refer to FIG. 1). As specification data of vehicle 1, for example, the vehicle weight W of the vehicle 1, load Mf added to each of the front side tyres T, load Mr added to each of the rear side tyres T, the distance Lf in the back-and-forth direction between the center of the gravity G and each of the front tyres T, the distance Lr in the back-and-forth direction between the center of the gravity G and each of the rear tyres T, and the inertia mass I are memorized in the memory 31.

In the tyre managing apparatus described above, the control device 30 computes lateral forces Yf, Yr added to each tyre T based on the specification data of the vehicle 1 memorized in the memory 31 and the detected results of the second acceleration sensor 42 and the yew acceleration sensor 50. The lateral forces Yf, Yr are forces in the lateral direction of the vehicle 1. The computed result is transmitted to and memorized in the transponder 10 of corresponding tyre T. Also, the control device 30 computes back-and-forth forces Tf, Tr added to each tyre T based on the specification data of vehicle 1 memorized in the memory 31 and the detected result of the first acceleration sensor 41. The back-and-forth forces Tf, Tr are forces in the back-and-forth direction of the vehicle 1. The computed result is transmitted to and memorized in the transponder 10 of corresponding tyre T.

In this case, computing the lateral forces Yf, Yr and the back-and-forth forces Tf, Tr by the control device 30 is able to be performed based on, for example, a general dynamics model shown in FIG. 2. FIG. 2 is the model showing a balance of the forces between the inertia force F1 in the lateral direction of the vehicle, the inertia force F2 in the rotational direction relative to the center of gravity G, and the lateral forces Yf, Yr of each of the tyres T. Also, FIG. 2 is the model showing a balance of the forces between the inertia force F3 in the back-and-forth direction of the vehicle 1 and the back-and-forth forces Tf, Tr of each of the tyres T. Thus, the lateral force Yf which is added to each of the front tyres T is calculated by the formula 1.

Yf={(1/2)×1/(Lf+Lr)}×{(Lr×Gy)+(I×γdt)} Formula 1

Also, the lateral force Yr which is added to each of the rear tyres T is calculated by the formula 2.

Yr={(1/2)×1/(Lf+Lr)}×{(Lf×Gy)+(I×γdt)} Formula 2

Also, the back-and-forth force Tf added to each of the front tyres T is calculated by the formula 3.

Tf=M×Gt×(Mf/M) Formula 3

Also, the back-and-forth force Tr added to each of the rear tyres T is calculated by the formula 4.

Tr=M×Gt×(Mr/M) Formula 4

On the other hand, The distance Lf, Lr, inertia moment I, the vehicle weight M, and the load Mf, Mr added to each of the tyres T are memorized in the memory 31. Also, the longitudinal acceleration Gt, the lateral acceleration Gy, and the yew angle acceleration γ dt are detected continuously by the first acceleration sensor 41, the second acceleration sensor 42, and the yew acceleration sensor 50. Thus, the control device 30 is able to, for example, detect the back-and-forth forces Tf, Tr and the lateral forces Yf, Yr continuously or at predetermined timing while the vehicle is being driven. The control device 30 is also able to make the transponders 30 of each of the tyres T memorize the computed results through each of the antennas 20. In this case, with regard to the predetermined timing, it is possible to perform the said calculation by the control device 30 once to every predetermined time (for example, once to a second), once to every predetermined distance running (for example, once to every 10 m running), or once to every predetermined rotation (for example, once to one rotation).

In this embodiment, with regard to respective tyres, the back-and-forth force Tf, Tr and the lateral force Yf, Yr which are added to each of tyres are calculated based on the distances Lf, Lr which are distance between each tyre T and the center of gravity G in the back-and-forth direction, the inertia moment I of the vehicle 1, the vehicle weight M of the vehicle 1, and the loads Mf, Mr added to each of the tyres T, which are as specification data of the vehicle 1, and based on the longitudinal acceleration Gt, the lateral acceleration Gy, and the yew angle acceleration γ dt, which are as state quantities of the vehicle 1. Also, the calculated results are memorized in the transponders 10 of corresponding tyres T. Therefore, by reading the calculated results memorized in the transponder 10 afterward, it is possible to confirm easily and certainly the history of the forces which are added to tread portion and the portions except the tread portion of the tyre T. Thus, it is extremely advantageous for managing tyre quality of portions except the tread portion of tyre.

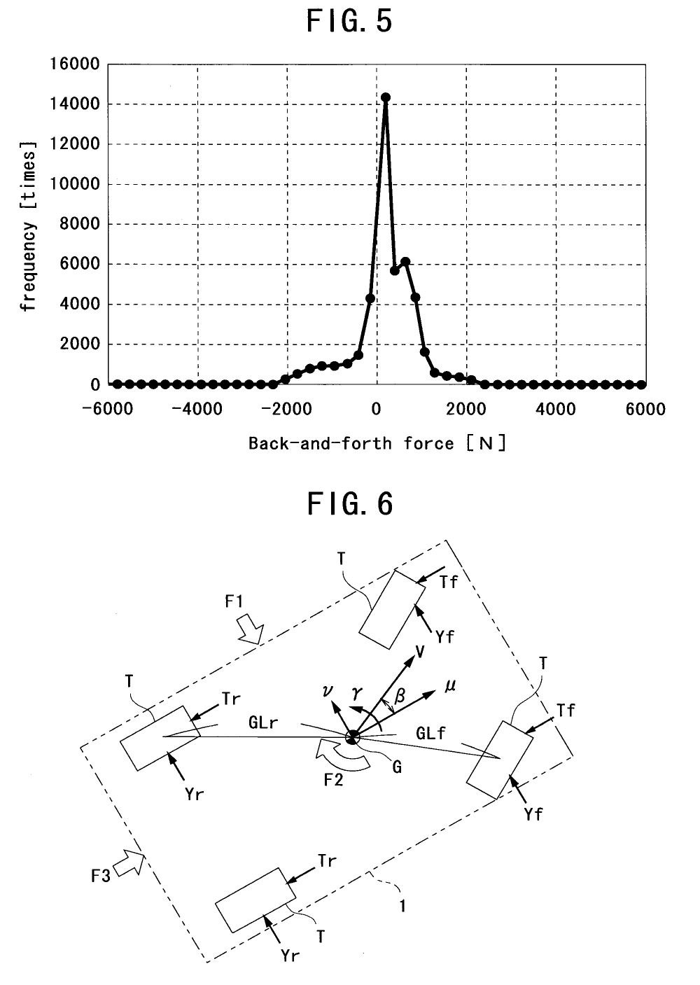

FIGS. 4 and 5 show the second embodiment of the present invention. FIG. 4 is an outlined plan view of a tyre managing apparatus and a vehicle, FIG. 5 is an example of frequency distribution data. The second embodiment provides a memorizing and processing device 32 between the control device 30 and each antenna 20 in the first embodiment. The memorizing and processing device 32 is as a making frequency distribution data device. The other compositions are the same as the first embodiment.

In this case, the memorizing and processing device 32 is made of well known computer, and is capable of memorizing the calculated results of the control device 30 at respective tyres T. Also, with regard to respective tyres T, the memorizing and processing device 32 respectively makes a data of frequency distribution with regard to each of the force Yf, Yr, Tf, Tr which are memorized.

In this tyre managing apparatus, as well as the first embodiment, for example, based on the general dynamics model shown in FIG. 2, calculations of the lateral forces Yf, Yr and the back-and-forth forces Tf, Tr are performed. Also, the control device 30 calculates the back-and-forth forces Tf, Tr and the lateral forces Yf, Yr, for example, at the predetermined timing as well as the first embodiment.

In the first embodiment, the calculated back-and-forth forces Tf, Tr and the calculated lateral forces Yf, Yr are memorized straight in the transponders 10. However, in this embodiment, each of the calculated forces Yf, Yr, Tf, Tr is memorized respectively in the memorizing and processing device 32 at respective tyres T. Also, when the calculated results are memorized in the memorizing and processing device 32, the memorizing and processing device 32 finds frequencies with regard to each amount of the forces at respective tyres T based on each of the forces Yf, Yr, Tf, Tr which are memorized. Also, the memorizing and processing device 32 makes the data of frequency distribution shown in FIG. 4. FIG. 4 shows a data of frequency distribution of the back-and-forth force Tf of one of the front tyres T. Also, the memorizing and processing device 32 memorizes the forces Yf, Yr, Tf, Tr for a predetermined term (for example, one month) at respective tyres T. And the memorizing and processing device 32 makes, at respective tyres T, the data of frequency distribution with regard to each of the forces Yf, Yr, Tf, Tr. Also, after the predetermined term has passed, the memorizing and processing device transmits the data of frequency distribution for the predetermined term to the corresponding tyre T and makes the tyre T memorize the data.

In this embodiment, as well as the first embodiment, with regard to respective tyres, the back-and-forth force Tf, Tr and the lateral force Yf, Yr which are added to each of tyres are calculated based on the distances Lf, Lr which are distance between each tyre T and the center of gravity G in the back-and-forth direction, the inertia moment I of the vehicle 1, the vehicle weight M of the vehicle 1, and the loads Mf, Mr added to each of the tyres T, which are as specification data of the vehicle 1, and based on the longitudinal acceleration Gt, the lateral acceleration Gy, and the yew angle acceleration γ dt, which are as state quantities of the vehicle 1. Also, the calculated results are memorized in the transponders 10 of corresponding tyres T. Therefore, by reading the calculated results memorized in the transponder 10 afterward, it is possible to confirm easily and certainly the history of the forces which are added to tread portion and the portions except the tread portion of the tyre T. Thus, it is extremely advantageous for managing tyre quality of portions except the tread portion of tyre.

Also, the data of frequency distribution of the calculated results is made, and the data of frequency distribution is memorized in the transponder 10. Therefore, when a history of forces added to the tyre T is confirmed by reading afterward the data of frequency distribution memorized in the transponder 10, it becomes capable to do that confirmation work easily and effectively.

Also, the data of frequency distribution is made of the calculated results for the predetermined term. Moreover, after the predetermined term has passed, the data of frequency distribution for the predetermined term is transmitted to the corresponding tyre T and memorized therein. It is possible to reduce the number of access times to the transponders 10, and it is possible to transmit the data to the transponders 10 effectively and certainly.

On the other hand, it is possible to attach a determining device for determining tyre state based on the said data of frequency distribution onto the vehicle 1. In this case, the determining device is connected to each antenna 20, and the determining device is capable of reading the data of frequency distribution of transponders 10 of each of the tyres T. Also, the determining device determines the state of the tyre T based on the ratio of the force which is greater than a predetermined amount in the data of frequency distribution. For example, when the data of frequency distribution of FIG. 4, the frequency ratio of back-and-forth forces Tf which are more than or equal to +2000N or less than or equal to −2000N, the determining device determines that the tyre state is not preferable.

In the second embodiment, the data of frequency distribution is made by the memorizing and processing device 32. However, it is possible to make the data of frequency distribution by the control device 30.

In the first and second embodiment, the lateral forces Yf, Yr and the back-and-forth forces Tf, Tr are computed based on the dynamics model shown in FIG. 2. On the other hand, it is possible to compute forces added to each of the tyres T based on another general dynamics model shown in FIG. 6. In this case, a well known sideslip angle detecting device for detecting sideslip angle β is further installed on the vehicle 1. Also, the control device 30 computes the back-and-forth speed μ of the vehicle 1 and the lateral speed ν of the vehicle 1 based on the detected results of the speed sensor 60 and the sideslip angle detecting device. Also, the control device 30 detects yew angle acceleration γ based on the detected results of the yew acceleration sensor 50. Also, the control device 30 computes forces added to each of the tyres T based on the specification data memorized in the memory 31 and the calculated acceleration μ, ν, γ. Also, as the specification data, the distance GLf between the center of gravity and the front tyre T is memorized in the memory 31, and the distance GLr between the center of gravity and the rear tyre T is memorized in the memory 31. Thus, the lateral force Yf added to the each of the front tyres T is calculated by the formula 5.

Yf=(Mf/M)×{M×(νdt+μ×γ)} Formula 5

Also, the lateral force Yr added to each of the rear tyres T is calculated by the formula 6.

Yr=(Mr/M)×{M×(νdt+μ×γ)} Formula 6

Also, the back-and-forth force Tf added to each of the front tyres T is calculated by the formula 7.

Tf=(Mf/M)×{M×(μdt−ν×γ)} Formula 7

Also, the back-and-forth force Tr added to each of the rear tyres T ias calculated by the formula 8.

Tr=(Mr/M)×{M×(μdt−ν×γ)} Formula 8

Moreover, the circumferential direction force Mf relative to the center of gravity G added to each of the front tyres T is calculated by the formula 9.

Mf=(Mr/M)×I×γdt/GLf Formula 9

The circumferential direction force Mr relative to the center of gravity G added to each of the rear tyres T is calculated by the formula 10.

Mr=(Mr/M)×I×γdt/GLr Formula 10

Also, in above mentioned embodiments, each of the forces Yf, Yr, Tf, Tr, Mf, Mr added to each of the tyres T is memorized in the memory 31. On the other hand, for example, it is possible to memorize the calculated results of the (νdt+μ×γ) of the formula 5 used for calculating the force Yf into the transponders 10 instead of memorizing the lateral forces Yf added to each of the tyres. Also, (νdt+μ×γ) is a coefficient related to the force Yf. In this case, it is possible to confirm the history of the forces added to the tyre T by reading the coefficients related to the forces from the transponders 10. Thus, it is possible to achieve the effects which are equal or similar to the effects mentioned above.

Also, it is possible to memorize characteristic data of each of the tyres T which are attached to the vehicle 1. And it is possible to compute forces added to each of the tyres T or coefficients thereof based on the state quantity of the vehicle 1 and the characteristic data of each of the tyres T. In this case, since the characteristic data of each of the tyres T are considered, it becomes possible to improve the accuracy of the calculated results.

Also, it is possible to detect strains each of the tyres T. Also, the detected results are able to be memorized in the transponders 10 as well as the said calculated results of the forces added to the tyres T by the control device 30. By this, it becomes possible to confirm the history of the forces added to the tyre T based on the forces and strains added to the tyre T. Thus, it is more advantageous for managing the tyre quality of the portions except the tread portion of the tyre T. Moreover, detecting of the strains is able to be performed by using the system described in Japanese Patent Publication 2004-500561 or well known strain gauges.

Also, it is possible to detect temperatures of each of the tyres T. Also, the detected results are able to be memorized in the transponders 10 as well as the said calculated results of the forces added to the tyres T by the control device 30. By this, it becomes possible to confirm the history of the forces and heat added to the tyre T based on the forces added to the tyre T and the temperatures. Thus, it is more advantageous for managing the tyre quality of the portions except the tread portion of the tyre T. Moreover, detecting of the temperatures is able to be performed by using well known thermocouples or infrared thermometer.

Also, it is possible to detect air pressures of each of the tyres T. Also, the detected results are able to be memorized in the transponders 10 as well as the said calculated results of the forces added to the tyres T by the control device 30. By this, it becomes possible to confirm the history of the forces added to the tyre T based on the forces and pressures added to the tyre T and the air pressures. Thus, it is more advantageous for managing the tyre quality of the portions except the tread portion of the tyre T. Moreover, detecting of the air pressures is able to be performed by using well known air pressure sensors or like that. Also, detecting of the air pressure is able to be performed by using air pressure sensor which is mounted on the transponder 10.

The preferred embodiments described in this specification are illustrative and not restrictive. The scope of invention is given by the appended claims, and all changes and modifications included in the meaning of claims are embraced in the present invention.

What is claimed is:

1. A tyre managing apparatus for managing a force which is added to each tyre or a coefficient thereof, the tyre managing device which manages the force or the coefficient at respective tyres of vehicle installed with tyres to which a plurality of transponders are respectively attached, the tyre managing apparatus comprising:
a memory for memorize a specification data of the said vehicle;
a detecting device for detecting a state quantity of the vehicle;
a computing device for computing the said force or the said coefficient at respective tyres using at least the specification data of vehicle of the memory and the detected state quantity; and
a transmitter for transmitting the force or the coefficient computed by the computing device to the transponder of corresponding tyre, the transmitter for making the transponder memorize the force or the coefficient.

2. A tyre managing apparatus for managing a force which is added to each tyre or a coefficient thereof, the tyre managing device which manages the force or the coefficient at respective tyres of vehicle installed with tyres to which a plurality of transponder are respectively attached, the tyre managing apparatus comprising:
a memory for memorize a specification data of the said vehicle;
a detecting device for detecting a state quantity of the vehicle;
a computing device for computing the said force or the said coefficient at respective tyres using at least the specification data of vehicle of the memory and the detected state quantity;
a making frequency distribution data device for making the data of frequency distribution of the force or the coefficient which are computed by the computing device at respective tyres; and
a transmitter for transmitting the data of frequency distribution made by the making frequency distribution data device to the transponder of corresponding tyre, the transmitter for making the transponder memorize the data of frequency distribution.

3. The tyre managing apparatus according to claim 2, further comprising:
a determining device capable of receiving the data of frequency distribution memorized by the transponder, the determining device for determining tyre state based on a ratio of the force or the coefficient which are greater than a predetermined amount in the data of frequency distribution.

4. The tyre managing apparatus according to claim 1, further comprising:
a strain detecting device capable of detecting a strain of each tyre respectively,
wherein the said transmitter is constructed so as to make the transponder of corresponding tyre memorize a detected result of the strain detecting device.

5. The tyre managing apparatus according to claim 1, further comprising:
a temperature detecting device capable of detecting a temperature of each tyre respectively,
wherein the said transmitter is constructed so as to make the transponder of corresponding tyre memorize a detected result of the temperature detecting device.

6. The tyre managing apparatus according to claim 1, further comprising:
a air pressure detecting device capable of detecting a air pressure of each tyre respectively,
wherein the said transmitter is constructed so as to make the transponder of corresponding tyre memorize a detected result of the air pressure detecting device.

7. The tyre managing apparatus according to claim 2, further comprising:
a strain detecting device capable of detecting a strain of each tyre respectively,
wherein the said transmitter is constructed so as to make the transponder of corresponding tyre memorize a detected result of the strain detecting device.

8. The tyre managing apparatus according to claim 2, further comprising:
a temperature detecting device capable of detecting a temperature of each tyre respectively,
wherein the said transmitter is constructed so as to make the transponder of corresponding tyre memorize a detected result of the temperature detecting device.

9. The tyre managing apparatus according to claim 2, further comprising:
a air pressure detecting device capable of detecting a air pressure of each tyre respectively,
wherein the said transmitter is constructed so as to make the transponder of corresponding tyre memorize a detected result of the air pressure detecting device.
